(19) United States
(12) Patent Application Publication
(10) Pub. No.: US 2025/0378339 A1
(43) Pub. Date: Dec. 11, 2025

(54) Self-Supervised Learning for User Modeling

(71) Applicant: Google LLC, Mountain View, CA (US)

(72) Inventors: Lin Ning, San Jose, CA (US); Zhengyi Wu, Redmond, WA (US); Karan Singhal, Roslyn, NY (US); Philip Andrew Mansfield, Penticton (CA); Devora Berlowitz, Seattle, WA (US); Sushant Prakash, Scarsdale, NY (US); Bradley Ray Green, Bellevue, WA (US); Yuhan Liu, Ithaca, NY (US)

(21) Appl. No.: 18/737,670

(22) Filed: Jun. 7, 2024

(51) Int. Cl. G06N 3/0895

(52) U.S. Cl. CPC G06N 3/0895

(57) ABSTRACT

Provided are systems and methods for performing self-supervised learning (SSL) of user sequence representations. In particular, an example method can include obtaining sequences of user feature data, applying various augmentation techniques such as random masking or permutation, and then processing these through a user sequence model to generate embeddings. These embeddings can be further transformed by a projection network, and a correlation-based loss function, such as the Barlow Twins loss, can be used to refine the model parameters.

### FIELD

The present disclosure relates generally to machine learning. More particularly, the present disclosure relates to techniques for training machine-learning models to generate latent representations of users in a self-supervised manner.

### BACKGROUND

In various settings it can be useful to generate or use a representation of a user. In particular, in the context of user modeling and machine learning, the term “representation” can refer to the transformation of raw user data into a format or set of features that effectively captures the underlying patterns and characteristics of the data. These representations, often in the form of numerical vectors or “embeddings”, enable machine learning models to process and analyze the data more efficiently, facilitating tasks such as prediction and classification related to user behaviors and preferences.

One challenge associated with generating user representations is the scarcity of labeled training data. Labeled data is valuable for training machine learning models to recognize and predict patterns accurately. However, acquiring such labeled data can include a number of different challenges, including high costs, substantial time requirements, and/or the need for expert knowledge to ensure accuracy and relevance of the labels. Moreover, certain types of user data are inherently difficult to label accurately, complicating the task further.

The lack of sufficient labeled data restricts the ability of traditional supervised learning models to perform optimally. These models typically require extensive labeled datasets to learn effectively, which are not always available in real-world scenarios, especially when dealing with vast and continuously evolving user interaction datasets. Consequently, there is a need for an approach that can efficiently leverage unlabeled data to enable the learning of user representations.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to perform self-supervised learning of user representations. The method includes obtaining, by a computing system comprising one or more computing devices, a sequence of feature data associated with a user. The method includes performing, by the computing system, one or more first augmentation operations on the sequence of feature data to generate a first augmented sequence of feature data. The method includes performing, by the computing system, one or more second augmentation operations on the sequence of feature data to generate a second augmented sequence of feature data. The method includes respectively processing, by the computing system, the first augmented sequence and the second augmented sequence with a user sequence model to respectively obtain a first sequence embedding and a second sequence embedding as respective outputs of the user sequence model. The method includes respectively processing, by the computing system, the first sequence embedding and the second sequence embedding with a projection network to respectively obtain a first projected representation and a second projected representation as respective outputs of the projection network. The method includes evaluating, by the computing system, a loss function that measures a correlation between the first projected representation and the second projected representation. The method includes modifying, by the computing system, one or more values of one or more parameters of at least the user sequence model based on the loss function.

Another example aspect of the present disclosure is directed to a computing system configured to perform self-supervised learning of a user sequence model. The computing system includes one or more processors and one or more non-transitory computer-readable media that store instructions for performing operations. The operations include obtaining, by the computing system, a sequence of feature data associated with a user. The operations include performing, by the computing system, one or more first augmentation operations on a sequence of feature data to generate a first augmented sequence of feature data. The operations include performing, by the computing system, one or more second augmentation operations on the sequence of feature data to generate a second augmented sequence of feature data. The operations include respectively processing, by the computing system, the first augmented sequence and the second augmented sequence with the user sequence model to respectively obtain a first sequence embedding and a second sequence embedding as respective outputs of the user sequence model. The operations include respectively processing, by the computing system, the first sequence embedding and the second sequence embedding with a projection network to respectively obtain a first projected representation and a second projected representation as respective outputs of the projection network. The operations include evaluating, by the computing system, a loss function that measures a correlation between the first projected representation and the second projected representation. The operations include modifying, by the computing system, one or more values of one or more parameters of at least the user sequence model based on the loss function.

Another example aspect of the present disclosure is directed to one or more non-transitory computer-readable media that collectively store a user sequence model. The user sequence model has previously been machine-learned via performance of training operations. The training operations include obtaining, by a computing system comprising one or more computing devices, a sequence of feature data associated with a user. The training operations include performing, by the computing system, one or more first augmentation operations on a sequence of feature data to generate a first augmented sequence of feature data. The training operations include performing, by the computing system, one or more second augmentation operations on the sequence of feature data to generate a second augmented sequence of feature data. The training operations include respectively processing, by the computing system, the first augmented sequence and the second augmented sequence with the user sequence model to respectively obtain a first sequence embedding and a second sequence embedding as respective outputs of the user sequence model. The training operations include respectively processing, by the computing system, the first sequence embedding and the second sequence embedding with a projection network to respectively obtain a first projected representation and a second projected representation as respective outputs of the projection network. The training operations include evaluating, by the computing system, a loss function that measures a correlation between the first projected representation and the second projected representation. The training operations include modifying, by the computing system, one or more values of one or more parameters of at least the user sequence model based on the loss function.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 provides a flowchart diagram of an example method for performing self-supervised learning according to example embodiments of the present disclosure.

FIG. 2 provides a graphical diagram of an example framework for performing self-supervised learning according to example embodiments of the present disclosure.

FIG. 3 provides a graphical diagram of an example framework for using a user representation model to perform a downstream task according to example embodiments of the present disclosure.

FIG. 4A depicts a block diagram of an example computing system that performs user sequence modeling according to example embodiments of the present disclosure.

FIG. 4B depicts a block diagram of an example computing device that performs user sequence modeling according to example embodiments of the present disclosure.

FIG. 4C depicts a block diagram of an example computing device that performs user sequence modeling according to example embodiments of the present disclosure.

Reference numerals that are repeated across plural figures are intended to identify the same features in various implementations.

### DETAILED DESCRIPTION

Generally, the present disclosure is directed to systems and methods for performing self-supervised learning (SSL) of user sequence representations. In particular, an example method can include obtaining sequences of user feature data, applying various augmentation techniques such as random masking or permutation, and then processing these through a user sequence model to generate embeddings. These embeddings can be further transformed by a projection network, and a correlation-based loss function, such as the Barlow Twins loss, can be used to refine the model parameters. This SSL approach can be beneficial in various downstream tasks like sequence-level classification or next item prediction, offering a flexible and robust framework for understanding and predicting user behavior based on their activity sequences.

More particularly, a computing system that performs self-supervised learning can begin by obtaining a sequence of user feature data, which can, for example, describe a series of user actions such as video views or movie ratings. For instance, the feature data might include sequences of actions taken by users on a digital platform, providing a basis for learning user preferences and behaviors without the need for explicitly labeled data.

The computing system can then perform augmentation operations to the sequence of user feature data. These operations can vary; for example, one can use random masking where certain items in the sequence are replaced with a mask token or segment masking where a contiguous subsequence is masked. Alternatively, permutation of the sequence items can be performed. These augmentations serve to create varied representations of the same data, which can help in learning more robust user sequence representations.

The augmented sequences are then processed by a user sequence model. In some implementations, this model can include an embedding layer that converts the augmented sequences into embedding vectors, which are then processed by a representation network to obtain sequence embeddings. For example, the embedding layer might transform action identifiers into dense vector representations, which the representation network processes further. In some examples, the representation network can be a convolutional neural network or a transformer-based model.

Following the generation of sequence embeddings, a projection network can be applied. This network can transform the sequence embeddings into projected representations, which can be higher-dimensional compared to the sequence embeddings. To provide an example, the projection network can include multiple layers of a multi-layer perceptron (MLP), which elevates the dimensionality of the embeddings to capture more complex patterns in the data.

Next, the computing system can evaluate a loss function. For example, the loss function can measure the correlation between the projected representations of the augmented sequences. In some implementations, this can include the use of a Barlow Twins loss function. This loss function can help in learning representations that are invariant to the specific augmentations applied, focusing instead on the underlying structure of the data.

Then, the parameters of the user sequence model can be modified based on the outcome of the loss function. For example, this iterative process of modification can be implemented using backpropagation algorithms that adjust the weights of the model to minimize the loss, thus refining the model's ability to generate useful sequence embeddings from user feature data.

After the self-supervised learning process described above, the user sequence model can be deployed to generate sequence-level embeddings for other sequences of user data for various downstream tasks. As examples, these tasks might include sequence-level classification, where the sequence embeddings are used to predict categorical labels, or next item prediction, which involves predicting the next item in a sequence given the previous items.

In some implementations, additional network structures suitable for specific downstream tasks can be appended to the user sequence model. For example, for sequence-level classification tasks, a two-layer MLP head might be added to the model, with the output dimension equal to the number of categories in the task. This allows the model to be tailored to the specific requirements of different applications.

Thus, the present disclosure provides computer-implemented methods and systems for performing self-supervised learning (SSL) of user sequence models, which can be particularly beneficial for large-scale recommendation systems. The proposed techniques can allow for the extraction of informative user and item representations from sequences of user feature data without the need for labeled training data.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The systems and methods of the present disclosure provide a number of technical effects and benefits. As one example, the proposed techniques can result in enhanced accuracy in downstream tasks. For instance, in some implementations, performance of the proposed SSL technique has demonstrated an increase in accuracy in downstream tasks such as next item prediction, compared to traditional dual encoder models. This improvement is a direct result of the unique architecture and the self-supervised learning approach employed.

Another example technical benefit relates to efficient handling of unlabeled data. In particular, in environments where labeled data is scarce or expensive to obtain, the disclosed method can be particularly advantageous. By employing SSL, particularly the adaptation of the Barlow Twins methodology, the system can effectively learn from unlabeled data. This is achieved by generating augmented data sequences and enforcing consistency between the representations of these sequences, thereby capturing the essential underlying patterns in the data without reliance on labels.

Another example technical benefit relates to robustness to data augmentation variations. In particular, the method can include performing various data augmentation techniques such as random masking, segment masking, and permutation. These augmentations introduce variability in the input data, which can help the model learn more robust and generalizable representations. For example, segment masking can allow the model to better understand and interpolate the contextual information in sequences, which is beneficial for tasks requiring an understanding of sequential and temporal dynamics.

Another example technical benefit relates to adaptability of the trained user representation model to different data domains. In particular, unlike traditional models that may rely on pre-trained weights suitable for specific types of data such as images or text, the disclosed method can be adapted to different domains by customizing the augmentation methods and network architectures. This adaptability makes it suitable for various applications beyond typical NLP and computer vision tasks, including those involving discrete and sporadic user activities in recommendation systems.

Finally, the proposed techniques also result in reduced computational expenditure. In particular, the disclosed SSL approach, particularly when using the Barlow Twins loss function, does not require large batches with many negative samples, which are typically needed in contrastive learning approaches. This can lead to a reduction in the computational resources required for training the models, making the method more accessible and feasible for use in different operational environments.

With reference now to the Figures, example embodiments of the present disclosure will be discussed in further detail.

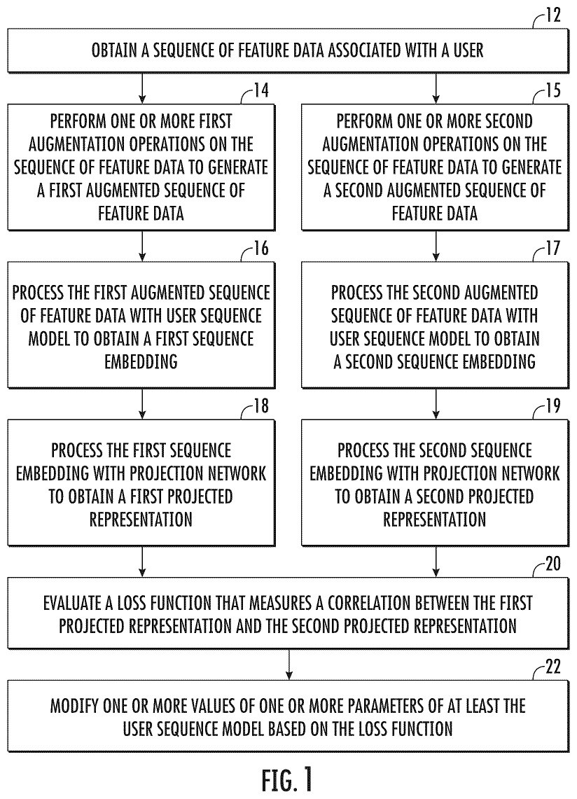

FIG. 1 depicts a flow chart diagram of an example method to perform self-supervised learning according to example embodiments of the present disclosure. Although FIG. 1 depicts steps performed in a particular order for purposes of illustration and discussion, the methods of the present disclosure are not limited to the particularly illustrated order or arrangement. The various steps of the method can be omitted, rearranged, combined, and/or adapted in various ways without deviating from the scope of the present disclosure. Each step in the flowchart can correspond to operations performed by a computing system, which includes one or more computing devices designed to execute the described method.

At step 12, the method begins by obtaining a sequence of feature data associated with a user. This sequence of feature data can include various user actions, such as video views, movie ratings, websites visited, search queries submitted, and/or other interactions within a digital environment, application, or platform.

For example, some implementations of the present disclosure assume that users can perform an action from a finite discrete domain D. The user sequence model U: [symbol] ^{d}^{ᵣ} takes as input a sequence of user items with length [symbol] , denoted by

$$u = ( {u}_{1} , … , {u}_{ℓ} ) ∈ {D}^{ℓ} .$$

In some implementations, each uᵢ can be viewed as an integer-valued identifier that uniquely represents a user's action (e.g. a movie watched by the user). In other implementations, each uᵢ can be raw and/or unstructured feature data.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Referring still to FIG. 1, at steps 14 and 15, the computing system can perform first and second augmentation operations on the sequence of feature data to generate a first augmented sequence of feature data and a second augmented sequence of feature data, respectively. These augmentation operations can include methods such as random masking, where items in the sequence are randomly replaced with a mask token, segment masking, where a contiguous segment of the sequence is replaced, or permutation, where the order of items in the sequence is shuffled.

In particular, during self-supervised pretraining, for each batch of sequences U=[u₁, . . . , u_{b}], the computing system can apply two independent augmentations and obtain two batches of augmented sequences U₁, U₂.

In example augmentation operation is a random masking (RM) operation. In some implementations of random masking, each item in the sequence can be replaced with the mask token [mask] independently with probability p∈(0, 1).

Another example augmentation operation is segment masking (SM). In some implementations of segment masking, the computing system can randomly select a subsequence of length └ [symbol] ┘, p∈(0,1) and replace all items in the subsequence with the mask token [mask].

Another example augmentation operation is a permutation operation. In some implementations of permutation, the input sequence is permuted uniformly at random. This augmentation method may be useful for position-invariant downstream tasks.

In steps 16 and 17, the first and second augmented sequences of feature data are processed with a user sequence model to obtain a first sequence embedding and a second sequence embedding, respectively.

In some implementations, the user sequence model includes an item embedding layer that transforms action identifiers into dense vector representations. Following this, a representation network processes these embeddings to generate sequence embeddings that capture the essential features of the user interactions.

For example, in some implementations, the sequence u is first passed through an item embedding layer E: [symbol] , which converts each integer ID (or other element in the sequence u) into a dₑ-dimensional embedding vector.

Then, a representation network R: [symbol] ^{d}^{ᵣ} transforms each sequence of embeddings into a sequence-level representation with dᵣ dimensions. Thus the user sequence model can be denoted as

$$U = R ∘ E$$

The choice of the representation network R is flexible. Some example implementations use a simple convolutional neural network for simplicity. Other example implementations can use more powerful models such as Transformers for best performance.

At steps 18 and 19, the first and second sequence embeddings are processed with a projection network to obtain a first projected representation and a second projected representation. In one example, the projection network can include multiple layers of a multi-layer perceptron (MLP), which increases the dimensionality of the embeddings to capture more complex patterns in the sequence data.

In particular, in some implementations, the projection network can be expressed as P: [symbol] ^{d}^{ᵣ} [symbol] ^{d}^{ₚ} with dₚ>dᵣ. The projection network can lift the sequence-level representation obtained from U into higher dimensions. The model with projection layers can be denoted as:

$$BT := P ∘ R ∘ E .$$

At step 20, a loss function is evaluated to measure the correlation between the first projected representation and the second projected representation. This loss function, such as the Barlow Twins loss function, can be designed to ensure that the learned representations are invariant to the specific augmentations applied and focus on capturing the underlying structure of the data.

Finally, at step 22, the method concludes by modifying one or more values of one or more parameters of at least the user sequence model based on the loss function. This modification can include performing backpropagation algorithms to adjust the user sequence weights of the model, refining its ability to generate useful sequence embeddings from user feature data.

For example, in some implementations, at step 20, the first projected representation and the second projected representation can be mean-centered along the batch dimension, denoted by

$${Y}^{i} = [ {y}_{1}^{i} , … , {y}_{{d}_{p}}^{i} ] , i = 1 , 2.$$

As step 22, the computing system can operate to minimize the Barlow Twins loss,

$${ℒ}_{BT} := {\sum }_{i = 1}^{{d}_{p}} ( 1 - {C}_{ij} ) + λ {\sum }_{i \neq j} {C}_{ij}^{2} \qquad ( 1 )$$

$$where$$

$${C}_{ij} := \frac{{\sum }_{j = 1}^{b} {y}_{1 , j}^{1} {y}_{2 , j}^{1}}{\sqrt{{\sum }_{j = 1}^{b} {( {y}_{1 , j} )}^{2}} \sqrt{{\sum }_{j = 1}^{b} {( {y}_{2 , j} )}^{2}}}$$

is the cross correlation matrix along the batch dimension, and λ is a hyperparameter that balances the two terms. The loss enforces C to be close to an identical matrix, which guides the model to learn statistically independent components.

In some implementations, the projection network can also optionally also be trained (e.g., via modification of weights) at step 22. More generally, the method shown in FIG. 1 can be repeated over a large number of user sequences to train the model(s).

After training, the user sequence model can be deployed to perform or assist in performing a downstream task. For example, in the downstream tasks, the sequence representation model U can be used as a base model to process the input sequence and output a sequence level representation, from which task-specific neural networks can be applied.

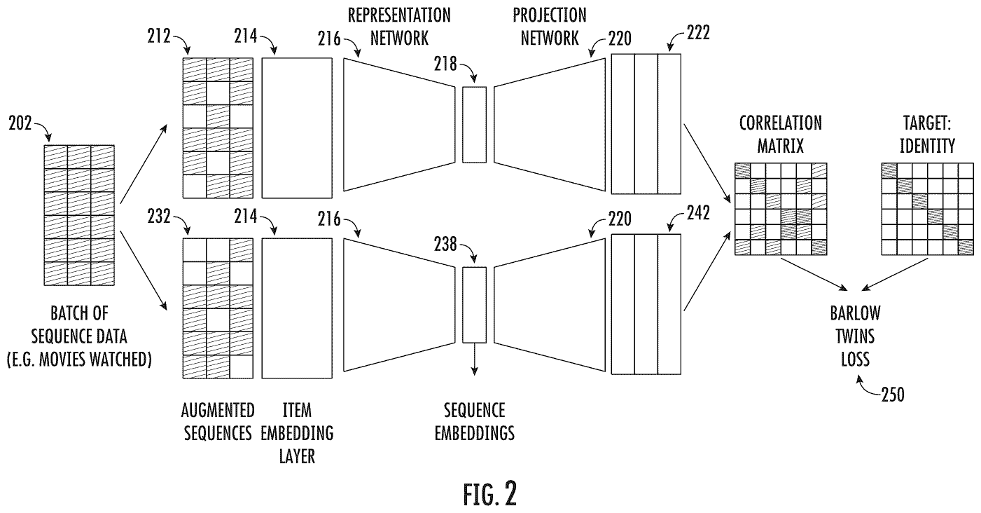

Referring now to FIG. 2, a schematic representation illustrates the self-supervised learning process for user sequence data. This figure demonstrates the flow of data through the various components of the system, illustrating the transformation of user sequence data into a format suitable for machine learning tasks.

Starting with the sequence of feature data associated with a user (202), which can, for example, include a batch of sequences such as movies watched by the user, the data undergoes a series of transformations to train a user sequence model to extract meaningful user sequence representations. This sequence data (202) is first subjected to augmentation operations to generate a first augmented sequence of feature data (212) and a second augmented sequence of feature data (232). These augmented sequences are then processed through an item embedding layer (214), which converts the discrete item identifiers (e.g., movie IDs) into dense vector representations. This transformation prepares the data for more complex processing and analysis.

Following the embedding layer, the augmented sequences are input into a representation network (216) to obtain a first sequence embedding (218) and a second sequence embedding (238). The representation network can be implemented using various neural network architectures, such as convolutional neural networks or transformers, depending on the specific requirements and complexity of the data.

The sequence embeddings are then passed through a projection network (220), resulting in a first projected representation (222) and a second projected representation (242). In one example, the projection network can include multiple layers of a multi-layer perceptron (MLP), which increases the dimensionality of the embeddings.

The self-supervised learning process illustrated in FIG. 2 also includes the evaluation of a correlation matrix and the subsequent application of the Barlow Twins loss (250). The correlation matrix measures the similarity between the projected representations of the two augmented sequences. The Barlow Twins loss function then uses this matrix to adjust the model parameters, encouraging the system to learn representations that are invariant to the specific augmentations applied. The target of this loss function is an identity matrix, indicating perfect independence of features across different augmentations.

Thus, FIG. 2 shows an illustration of Barlow Twins adapted to user sequence modeling. The model has two branches with shared weights to process two views of the same input batch, with a final Barlow Twins loss applied to the outputs of two branches.

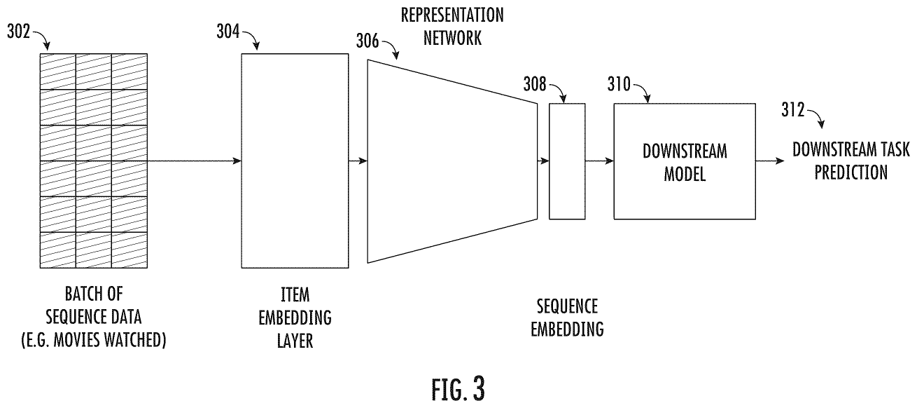

Referring now to FIG. 3, a schematic diagram illustrates the application of a trained user sequence model to a downstream task. The process begins with a batch of sequence data (302), which may include, for example, a list of movies watched by a user. This data is first processed by an item embedding layer (304), which transforms discrete item identifiers (such as movie IDs) into dense vector representations.

Following the item embedding layer, the vector representations are input into a representation network (306). In some implementations, this network can be a convolutional neural network (CNN) or a transformer-based model, which processes the embeddings to generate sequence embeddings (308). The sequence embeddings aim to capture the essential features and patterns of user interactions, such as viewing habits or preferences, based on the sequence data provided.

The sequence embeddings are then utilized by a downstream model (310), which is tailored to specific tasks such as sequence-level classification or next item prediction. This model processes the sequence embeddings to make relevant predictions or classifications (312). These downstream predictions can enhance user experience in recommendation systems by providing personalized content suggestions or insights.

For instance, in a sequence-level classification task, the downstream model might include a multi-layer perceptron (MLP) that classifies sequences into categories such as user demographic groups or preferred genres. In a next item prediction task, the model might predict the next movie a user is likely to watch based on their historical data.

More particularly, after pretraining, some example implementations can remove the projection network and only keep the sequence representation model U. Some example implementations can then append additional network structure suitable for each different downstream tasks.

As one example, for sequence-level classification tasks, some example implementations can add a 2-layered MLP head to U, with the output dimension equal to the number of categories in the task.

As another example, for the next item prediction task in sequential recommendation systems, some example implementations can build a dual encoder model on top of U. For example, the context tower is U with an additional 2-layered MLP which maps the sequence-level representation to the space of item embeddings. The item tower is simply the item embedding E. Contrastive loss can be applied during training.

When training on downstream tasks, the representation model U can have either fixed or trainable weights. With fixed weights, the quality of the representations can be directly evaluated. With trainable weights, best possible performance can be achieved, particularly in cases where there is abundant training data for the downstream task.

The architecture depicted in FIG. 3 allows for flexibility in terms of the specific components used, such as different types of representation networks or downstream models, depending on the requirements and complexity of the tasks at hand. This adaptability makes the system robust and effective across various applications, not only in movie recommendations but potentially in other recommendation systems where user behavior data is available.

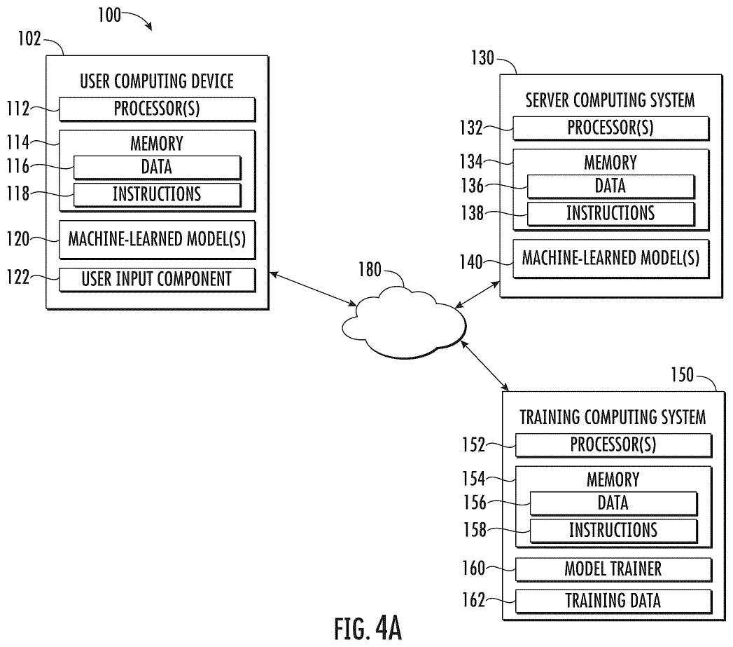

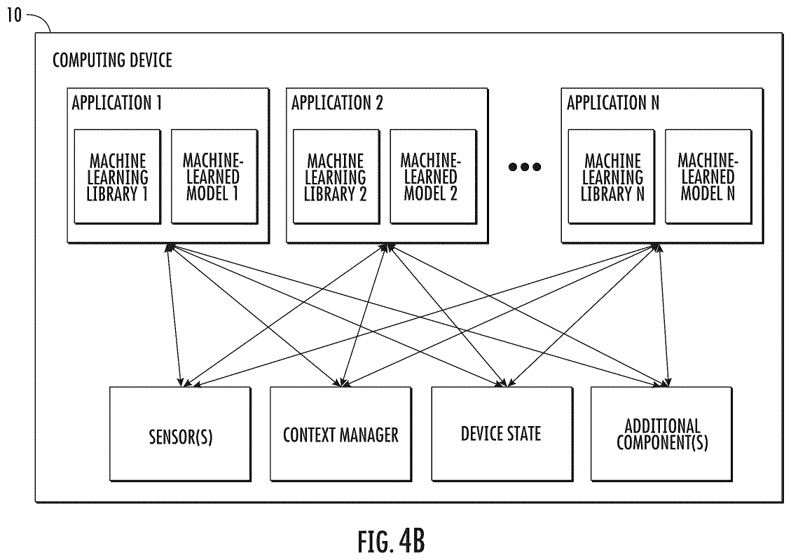

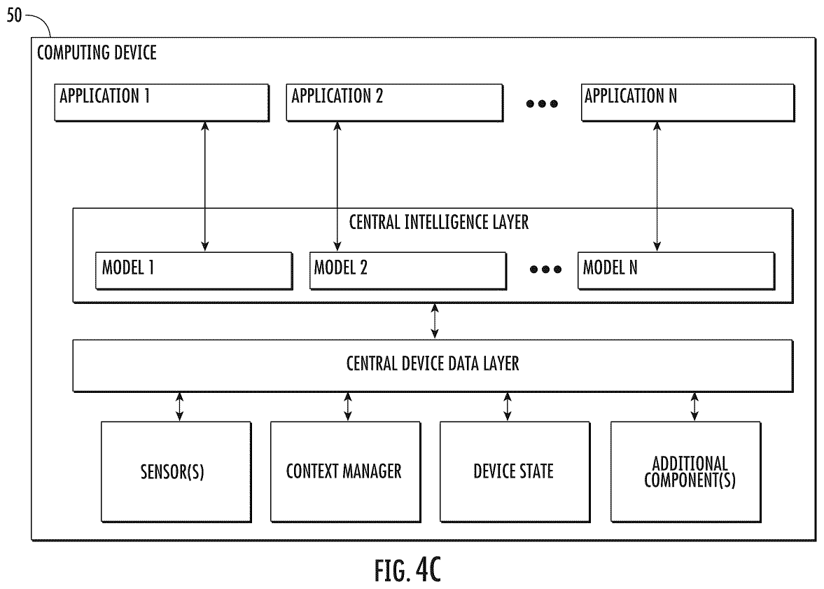

FIG. 4A depicts a block diagram of an example computing system 100 that performs user sequence modeling according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-3.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel user sequence modeling across multiple instances of user data).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a user sequence modeling service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-3.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, unlabeled sequences of user feature data.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to perform self-supervised learning of user representations, the method comprising:
obtaining, by a computing system comprising one or more computing devices, a sequence of feature data associated with a user;
performing, by the computing system, one or more first augmentation operations on the sequence of feature data to generate a first augmented sequence of feature data;
performing, by the computing system, one or more second augmentation operations on the sequence of feature data to generate a second augmented sequence of feature data;
respectively processing, by the computing system, the first augmented sequence and the second augmented sequence with a user sequence model to respectively obtain a first sequence embedding and a second sequence embedding as respective outputs of the user sequence model;
respectively processing, by the computing system, the first sequence embedding and the second sequence embedding with a projection network to respectively obtain a first projected representation and a second projected representation as respective outputs of the projection network;
evaluating, by the computing system, a loss function that measures a correlation between the first projected representation and the second projected representation; and
modifying, by the computing system, one or more values of one or more parameters of at least the user sequence model based on the loss function.

2. The computer-implemented method of claim 1, wherein respectively processing, by the computing system, the first augmented sequence and the second augmented sequence with the user sequence model comprises:
respectively converting, by the computing system using an embedding layer of the user sequence model, the first augmented sequence and the second augmented sequence into a first embedding vector and a second embedding vector; and
respectively processing, by the computing system, the first embedding vector and the second embedding vector with a representation network of the user sequence model to respectively obtain the first sequence embedding and the second sequence embedding as the respective outputs of the user sequence model.

3. The computer-implemented method of claim 1, wherein the sequence of feature data associated with the user comprises a sequence of actions taken by the user.

4. The computer-implemented method of claim 1, wherein the sequence of feature data associated with the user comprises a content items viewed by the user.

5. The computer-implemented method of claim 1, wherein the at least one of the one or more first augmentation operations or the one or more second augmentation operations comprises a random masking operation in which at least one item in the sequence of feature data is replaced with a mask token.

6. The computer-implemented method of claim 1, wherein the at least one of the one or more first augmentation operations or the one or more second augmentation operations comprises a segment masking operation in which a subsequence of at least two adjacent items in the sequence of feature data is replaced with mask tokens.

7. The computer-implemented method of claim 1, wherein the at least one of the one or more first augmentation operations or the one or more second augmentation operations comprises a permutation operation in which at least two items in the sequence of feature data are permuted.

8. The computer-implemented method of claim 1, wherein the loss function comprises a Barlow Twins loss function.

9. The computer-implemented method of claim 1, further comprising, after said modifying, deploying the user sequence model to generate sequence-level embeddings for other sequences of user data for a downstream task.

10. The computer-implemented method of claim 9, wherein the downstream task comprises sequence-level classification.

11. The computer-implemented method of claim 9, wherein the downstream task comprises next item prediction.

12. A computing system configured to perform self-supervised learning of a user sequence model, the computing system comprising one or more processors and one or more non-transitory computer-readable media that store instructions for performing operations, the operations comprising:
obtaining, by the computing system, a sequence of feature data associated with a user;
performing, by the computing system, one or more first augmentation operations on a sequence of feature data to generate a first augmented sequence of feature data;
performing, by the computing system, one or more second augmentation operations on the sequence of feature data to generate a second augmented sequence of feature data;
respectively processing, by the computing system, the first augmented sequence and the second augmented sequence with the user sequence model to respectively obtain a first sequence embedding and a second sequence embedding as respective outputs of the user sequence model;
respectively processing, by the computing system, the first sequence embedding and the second sequence embedding with a projection network to respectively obtain a first projected representation and a second projected representation as respective outputs of the projection network;
evaluating, by the computing system, a loss function that measures a correlation between the first projected representation and the second projected representation; and
modifying, by the computing system, one or more values of one or more parameters of at least the user sequence model based on the loss function.

13. The computing system of claim 12, wherein respectively processing, by the computing system, the first augmented sequence and the second augmented sequence with the user sequence model comprises:
respectively converting, by the computing system using an embedding layer of the user sequence model, the first augmented sequence and the second augmented sequence into a first embedding vector and a second embedding vector; and
respectively processing, by the computing system, the first embedding vector and the second embedding vector with a representation network of the user sequence model to respectively obtain the first sequence embedding and the second sequence embedding as the respective outputs of the user sequence model.

14. The computing system of claim 12, wherein the sequence of feature data associated with the user comprises a sequence of actions taken by the user.

15. The computing system of claim 12, wherein the sequence of feature data associated with the user comprises a content items viewed by the user.

16. The computing system of claim 12, wherein the at least one of the one or more first augmentation operations or the one or more second augmentation operations comprises a random masking operation in which at least one item in the sequence of feature data is replaced with a mask token.

17. The computing system of claim 12, wherein the at least one of the one or more first augmentation operations or the one or more second augmentation operations comprises a segment masking operation in which a subsequence of at least two adjacent items in the sequence of feature data is replaced with mask tokens.

18. The computing system of claim 12, wherein the at least one of the one or more first augmentation operations or the one or more second augmentation operations comprises a permutation operation in which at least two items in the sequence of feature data are permuted.

19. The computing system of claim 12, wherein the loss function comprises a Barlow Twins loss function.

20. One or more non-transitory computer-readable media that collectively store a user sequence model, wherein the user sequence model has previously been machine-learned via performance of training operations, the training operations comprising:
obtaining, by a computing system comprising one or more computing devices, a sequence of feature data associated with a user;
performing, by the computing system, one or more first augmentation operations on a sequence of feature data to generate a first augmented sequence of feature data;
performing, by the computing system, one or more second augmentation operations on the sequence of feature data to generate a second augmented sequence of feature data;
respectively processing, by the computing system, the first augmented sequence and the second augmented sequence with the user sequence model to respectively obtain a first sequence embedding and a second sequence embedding as respective outputs of the user sequence model;
respectively processing, by the computing system, the first sequence embedding and the second sequence embedding with a projection network to respectively obtain a first projected representation and a second projected representation as respective outputs of the projection network;
evaluating, by the computing system, a loss function that measures a correlation between the first projected representation and the second projected representation; and
modifying, by the computing system, one or more values of one or more parameters of at least the user sequence model based on the loss function.
